(19) United States
(12) Patent Application Publication
(10) Pub. No.: US 2025/0173568 A1
(43) Pub. Date: May 29, 2025

(54) EFFICIENT MULTI-MODAL MODELS

(71) Applicant: THE TORONTO-DOMINION BANK, TORONTO (CA)

(72) Inventors: Jesse Cole Cresswell, TORONTO (CA); Noel Vouitsis, Markham (CA); Zhaoyan Liu, TORONTO (CA); Satya Krishna Gorti, TORONTO (CA); Valentin Victor Villecroze, TORONTO (CA); Guangwei Yu, TORONTO (CA); Gabriel Loaiza Ganem, TORONTO (CA); Maksims Volkovs, TORONTO (CA)

(21) Appl. No.: 18/956,861

(22) Filed: Nov. 22, 2024

Related U.S. Application Data
(60) Provisional application No. 63/602,518, filed on Nov. 24, 2023.

(51) Int. Cl. G06N 3/08; G06N 3/04

(52) U.S. Cl. CPC G06N 3/08; G06N 3/04

(57) ABSTRACT

Multi-modal models learn a joint latent space for relating data points across different modalities. To more effectively learn multi-modal models with reduced training requirements and greater benefit from limited multi-modal training data, a multi-modal model may be trained with fixed or pre-trained unimodal encoders that generate data representations in respective latent spaces. The multi-modal model is trained to learn a shared latent space while fixing the unimodal encoders, enabling training without storing the unimodal encoders in memory. Limited multi-modal data may also be augmented by generating synthetic data between commonly-labeled pairs in the respective modality's latent spaces. The effect of data diversity can also be determined by generating a diverse data set with respect to the data points in latent space, enabling measurement of performance of the multi-modal model on limited training data.

### CROSS-REFERENCE TO RELATED APPLICATION

This application claims the benefit of U.S. Provisional Application No. 63/602,518, filed Nov. 24, 2023, the contents of which is hereby incorporated by reference in its entirety.

### BACKGROUND

This disclosure relates generally to improved multi-modal models and more particularly to efficient training, data augmentation, and training data evaluation for multi-modal models.

The general objective of multi-modal learning is to build universal models that can jointly relate data of various modalities. These modalities can include various types of data such as image, text, audio, and video. A standard approach to building multi-modal models is to train them end-to-end on data paired across all modalities of interest. However, this approach generally does not scale well since training largescale multi-modal models from scratch can quickly become very compute and data intensive

While some multi-model approaches focus on learning a single shared latent space where multiple modalities can be jointly encoded, these approaches have generally been computationally burdensome. For example, these approaches have historically trained one or both encoders from scratch, requiring expensive gradient computations spanning many GPUs. In addition, these typically also use internet-scale data sets—image-text multi-modal models may use image-text pairs ranging in quantity from 400 M to 5 B pairs, and these datasets are often not made publicly available. These approaches generally require extensive training data and available computation. Recent successes in multi-modal fusion have been largely driven by large-scale training regimes requiring many GPUs, and often relying on datasets of billions of multi-modal pairs. This presents a cost that is unacceptable for many practical scenarios where access to compute is limited and where multi-modal data is scarce. It is thus important to design efficient frameworks that can improve performance of multi-modal models.

Prior approaches to data augmentation typically lose inherent semantic meaning of data and can penalize, rather than improve, model performance. In the natural image domain, common augmentations include horizontal flips, random crops, and color jitter applied to the ambient space of the image themselves, which are intended to leave semantic information unchanged. However, designing such augmentations in any given domain requires expert knowledge of which transformations preserve semantic information. For example, naively applying color jitter on the medical image domain can destroy the most relevant information for tasks like cancer classification. Furthermore, handcrafted augmentation schemes typically do not readily transfer to other modalities. This effect is evidenced by the scarcity of modality-agnostic augmentation schemes. Additional approaches for augmenting data, particularly in multi-modal settings, are needed for improving performance with the relatively limited training data available (and that is relatively expensive to obtain).

### SUMMARY

A multi-modal model is trained based on pre-trained unimodal encoders. Each unimodal encoder (which may also be referred to as a unimodal model) may be trained to learn a latent space for the respective modality. For example, a unimodal model for images may learn a latent space for images, while a unimodal model for audio may learn a latent space for audio. Rather than train these unimodal models jointly with a shared latent space, the multi-modal model learns parameters for respective adaptor models to the shared latent space based on the pre-trained unimodal models. This enables the unimodal models to be trained with data specific to the respective modality, typically enabling increased availability of training data and learning of rich latent spaces for each modality without requiring multi-modal data. In addition, during training of the multi-modal adaptor models, representations of data samples in modality-specific latent spaces can be pre-computed by applying the respective unimodal encoders to respective modalities of the multi-modal training data (i.e., including paired data points in multiple modalities). As such, training the multi-modal model may use the paired modality-specific latent representations without holding the unimodal encoders or ambient data points in memory, dramatically reducing memory and processing requirements while maintaining highly effective model results.

In addition, additional training data for multi-modal model training may be generated by combining data points in the respective modality's latent space, rather than in ambient space. While prior augmentation schemes attempted to modify data points in ambient space (e.g., by blurring, jittering, or blending images in the ambient image space), augmented training data is generated using the respective latent spaces. To prevent loss of semantic information, the generated data is created by determining a blending ratio and using the blending ratio to combine the latent representations for training data pairs. Each training data pair includes data samples in each modality and having respective latent representations in each modality's latent space (as learned and output by the respective unimodal encoders). A synthetic data pair is generated by combining the latent representations of the training data pairs in each modality's latent space. In addition, training data pairs are selected that have the same label (e.g., positive training pairs), such that the “blend” of the two pairs may still be expected to have the same label. That is, a position between the two pairs in a latent space with learned relationships (i.e., expected to be meaningful in the modality) should retain the same label when the same blending ratio is applied to both modalities. These augmented data points may be selected for positive as well as negative training pairs, enabling additional data points to be used for training the multi-modal model while maintaining semantically useful relationships between the latent spaces. In addition, by applying this approach to latent spaces, no additional domain knowledge is necessary for customizing this augmentation to specific modalities.

To obtain the highest benefit from a particular set of training data and evaluate the relative effect of diversity of data samples within a training set, a subset of training data may be obtained that represents a “maximally diverse” set of data points with respect to the presentation in a latent space. To do so, a similarity matrix may be constructed having values that represent a relationship between training data samples in the latent space. In various embodiments, the values may be determined based on the latent representations of the training data samples, and may include a cosine similarity between the latent representations. The diverse subset may be determined, in some embodiments, by a determinant point process (DPP) that samples data points based in part on the effect on a matrix determinant. The determinant point process may be k-DPP, in which k data points are selected by the determinant point process, such that the maximally diverse subset of different sizes may be identified. When using the latent representations to generate the similarity matrix, the determinant point process may fail to identify a subset larger than the number of dimensions in the latent representation as the dimensionality of the latent representations may represent a maximum number of degrees of freedom isolatable by the determinant point process. In one embodiment, the similarity matrix includes an exponent of the cosine similarity, which enables the selection process to effectively select a diverse data set larger than the number of dimensions of the latent space. The multi-modal model may then be trained with this data set of diverse training samples and its performance compared to the model when trained with a different subset having a different number of data samples or randomly-selected data samples. These metrics may be used to evaluate the expected benefit of additional diversity or quantity of training points, enabling limited resources for gathering further training data to be effectively directed to the additional training data providing increased benefit.

### BRIEF DESCRIPTION OF THE DRAWINGS

FIG. 1 illustrates components of a multi-modal modeling system 100, according to one embodiment.

FIG. 2 illustrates an example model architecture and training dataflow, according to one embodiment.

FIG. 3 shows an example dataflow for generating synthetic training data pairs, according to one embodiment.

FIG. 4 shows an example data flow for applying a multi-modal model to a data sample in a first modality and obtain a data sample in a second modality, according to one embodiment.

FIG. 5 provides an example method for training a multi-modal model, according to one or more embodiments.

FIG. 6 shows example experimental performance of a multi-modal model according to various aspects of a training data set.

FIG. 7 is an example flowchart for determining and using a diverse subset of training data based on latent representations.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

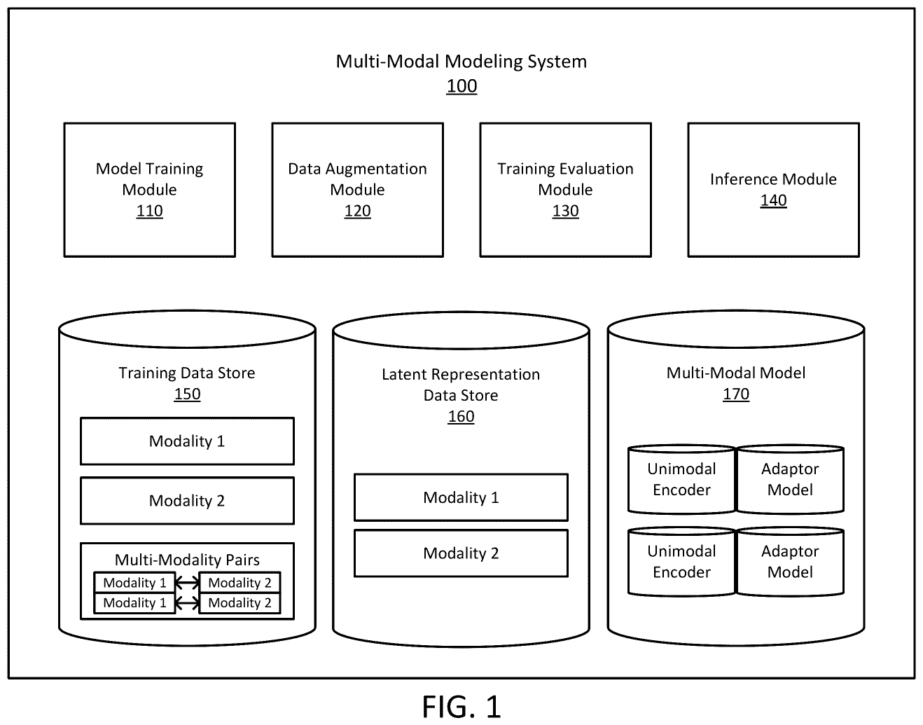

FIG. 1 illustrates components of a multi-modal modeling system 100, according to one embodiment. The multi-modal modeling system 100 is illustrated here with various components for model training, data augmentation, training evaluation, and data inference, including the computing modules and data stores as further discussed below. In various embodiments, the multi-modal modeling system 100 includes more or fewer components and may include communicating with other systems for performing various aspects described herein. For example, in certain embodiments, the multi-modal system may use pre-trained unimodal encoders, such that training of the unimodal encoders may be performed by another system and using separate training data. The multi-modal modeling system 100 may also communicate with additional systems and devices for various purposes, such as obtaining training data, coordinating on model training, receiving requests for model inference, and so forth.

Generally, the multi-modal modeling system 100 provides for training and use of a multi-modal model 170. The multi-modal model 170 is a structure and set of parameters for modeling correspondences between more than one modality. The multi-modal model 170 includes a plurality of processing layers, configurable parameters, and various machine-learning components for performing its functions that may vary in various embodiments, for differing modalities, and as further discussed below.

The particular modalities of the multi-modal model 170 vary in different embodiments, and may include images, video, audio, text, and so forth. Each modality typically represents data in a respective ambient space, which typically reflects the way that the modality may be captured or ordinarily used (e.g., an RGB image captured by an image sensor or an audio recording by a microphone). As such, the ambient space for an image modality may include a set of pixels describing color (or greyscale) values across a height and width of the image. Similarly, an audio modality includes an ambient space describing the occurrence of various sound frequencies across a time span. The multi-modal model 170 typically has an objective of identifying correspondences between the different modalities, such as identifying an image of a cat as matching an audio description of “a picture of a cat.”

As used herein, a particular example (i.e., an input or output) in a particular modality may be referred to as a “data sample” or “data instance.” The multi-modal model 170 may include a plurality of unimodal encoders along with one or more adaptor models. Each unimodal encoder is a computer model for encoding a particular modality to a respective latent space, and typically is invertible, such that the unimodal encoder can decode a position in the latent space to an output in the respective ambient space of that modality. When a trained unimodal encoder model is applied to a data sample of that modality, the unimodal encoder generates a “position” in the latent space that represents the data sample, which may be termed a “latent representation” or a “latent vector” for that data sample. Depending on the particular modality and unimodal encoder, the latent space may have various dimensionalities, which may indicate the “size” of the latent space. In some embodiments, the latent representation may be represented as a multi-dimensional vector having a number of elements corresponding to the dimensionality of the respective latent space.

In general, after training of the respective encoder, the latent spaces typically encode relevant semantic information about a data sample in the values of the latent representation, such that the particular position of the data sample within the latent space (i.e., the specific values of the latent representation) encodes/represents meaningful information about the data sample. The particular unimodal encoder for each modality and its structure may differ in various embodiments, and may thus learn different latent spaces with differing dimensionalities. In some embodiments, the unimodal encoder may be a part of a generative model, such that samples may be drawn from a probability for obtaining new data samples in the ambient space. For certain generative models operating as unimodal encoders, the model may be expressly trained to learn a latent space and a probability distribution thereon. In some embodiments, the unimodal encoder may be trained as a classification system, such that the unimodal encoder is trained to generate representations of input data before applying classification heads for various labels to the representations. In this example, the “latent representation” of a data sample may be defined as the output of the model layers before evaluation by the classification heads (i.e., the “final” layer processing the data sample before an evaluation/prediction step).

In addition to the unimodal encoders, the multi-modal model 170 may include a plurality of adaptor models for processing latent representations in the respective latent spaces to a shared latent space. The adaptor models and shared latent space enable effective translation between the latent spaces of each modality and thus align the information encoded in one latent space to another, enabling effective translation between the modalities. The multi-modal model 170 may be trained by a model training module 110 that trains parameters of the multi-modal model 170 based on a set of training data in a training data store 150. In general, the training data store 150 may include a number of multi-modality training pairs that include data samples in each modality that are associated with one another. In addition, in embodiments in which the multi-modal modeling system 100 trains the unimodal encoder(s), the training data store 150 may also include training data for the respective modalities.

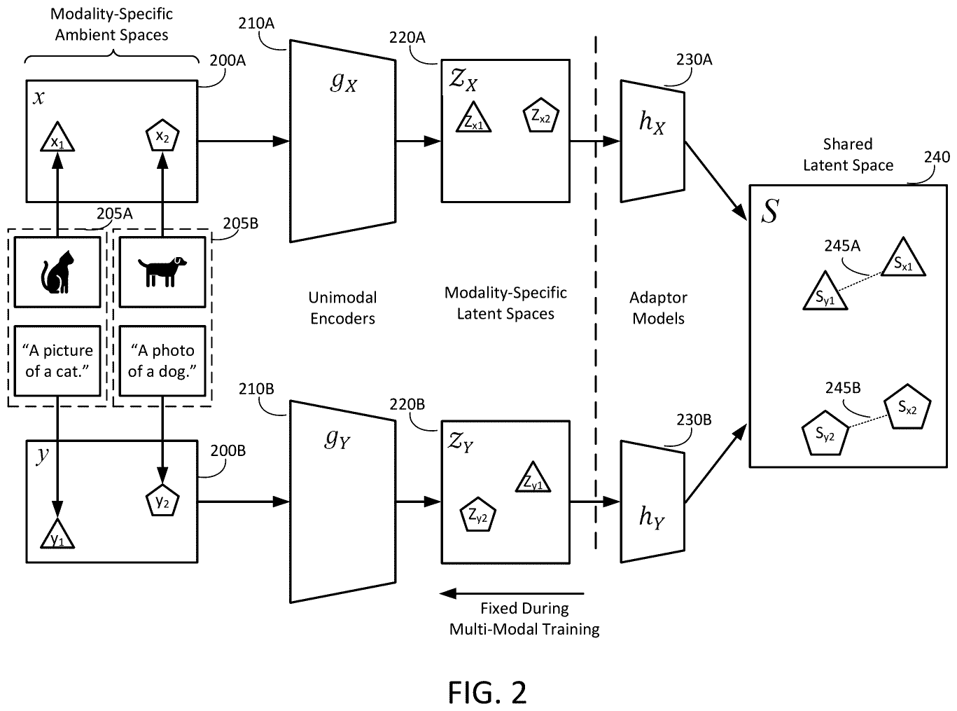

During training of the multi-modal model 170 the model training module 110 may generate and store latent representations in the latent representation data store 160. In certain embodiments, the unimodal encoders may remain fixed during training of the adaptor models, such that the output latent representations may also remain fixed. In these embodiments, the model training module 110 may generate latent representations for the multi-modality training pairs using the unimodal encoders and store the latent representations in a latent representation data store 160. As discussed below, this may enable training of the multi-modal model based on the latent representations without holding the ambient data samples or unimodal encoders in memory. The architecture and training of the multi-modal model 170 is further discussed below, particularly with respect to FIG. 2.

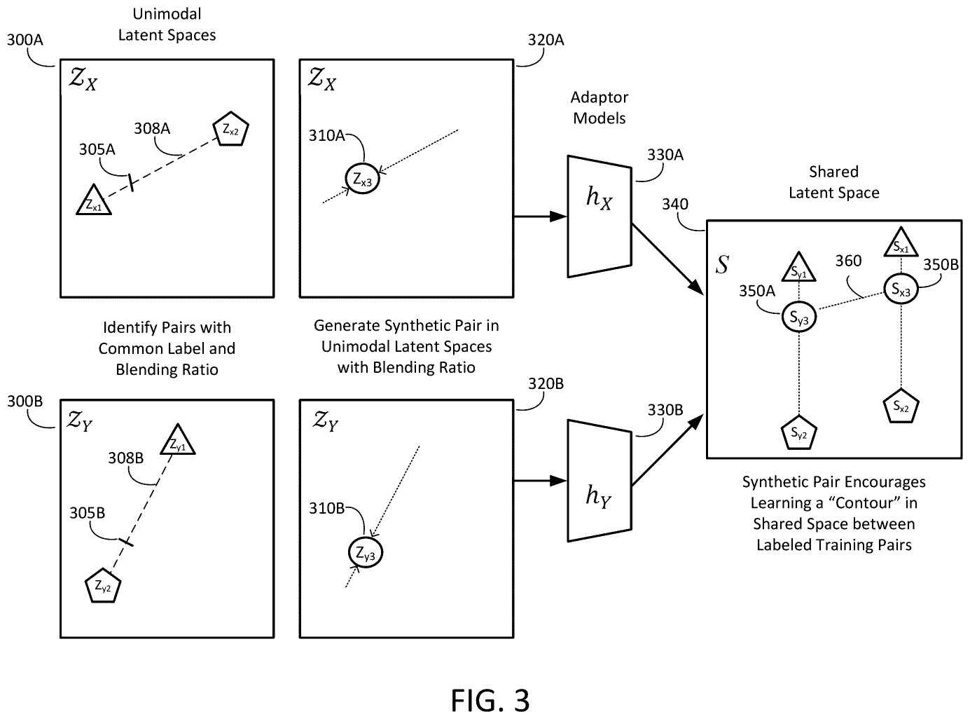

A data augmentation module 120 may also be used by the multi-modal modeling system 100 to augment labeled training data with synthetic data to improve training of the multi-modal model 170. The data augmentation module 120 obtains training data pairs and generates synthetic data that blends the latent representations of the labeled pairs. Rather than augment the training data in the ambient space, the data augmentation module 120 generates the synthetic data points in the latent spaces for the respective modalities. The data augmentation process is discussed further below with respect to FIG. 3.

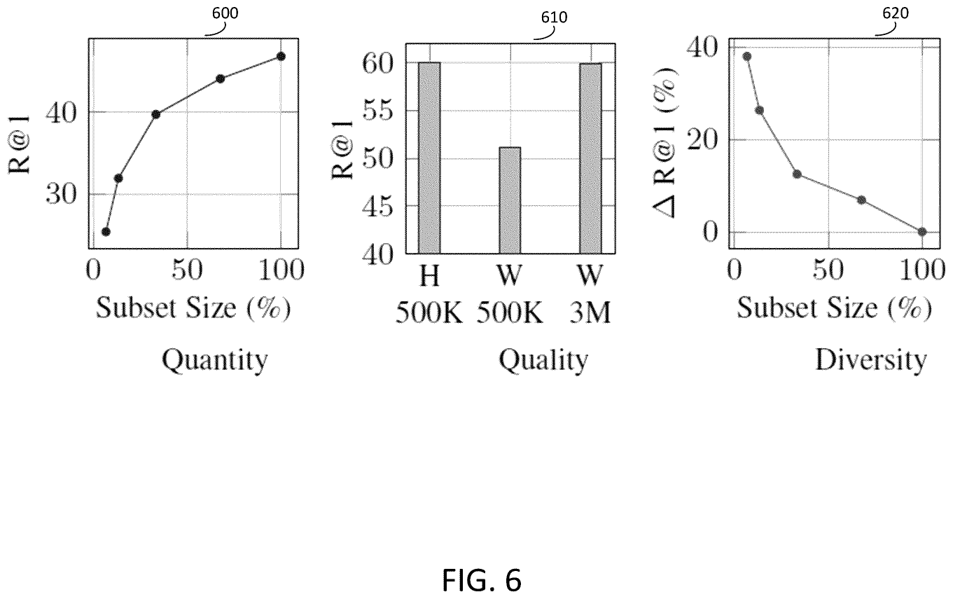

A training evaluation module 130 may be used to optimize the training data used for training the multi-modal model 170. In particular, the training evaluation module 130 may evaluate the training data to identify, among other characteristics, the effect of training data diversity on model training. The training evaluation module 130 may generate diverse subsets of data based on the latent representations of the training data and compare the performance of models trained on these diverse subsets of training data to other training data subsets. The generation of diverse subsets of training data and related evaluation is discussed further below, particularly with respect to FIG. 6.

Last, an inference module 140 may receive various requests for applying the trained multi-modal model 170 for various purposes. For example, the inference module 140 may receive a data sample in one modality and be requested to generate a data sample in another modality using the multi-modal model 170. As another example, the inference module 140 may receive a pair of data samples in different modalities and use the multi-modal model 170 to evaluate the similarity of the data samples by converting the data samples to the shared latent space and evaluating the similarity based on the representations in the shared latent space. Inference with the multi-modal model is also discussed further below.

### Multi-Modal Model Architecture and Training

FIG. 2 illustrates an example model architecture and training dataflow, according to one embodiment. The dataflow shown in FIG. 2 may be performed, for example, by the model training module 110 shown in FIG. 1. As shown in FIG. 2, each modality has data samples in respective ambient spaces 200A-B. In the example of FIG. 2, a first modality includes images, such that the ambient space 200A for the first modality includes images having pixels across a height and width of an image resolution. Similarly, a second modality in this example includes text strings, such that the ambient space 200B includes various text strings that may include multiple words forming a paragraph or a sentence. Data relating to the first modality may also be referenced herein as relating to a data set or data space “X” and data relating to the second modality may also be referenced herein as relating to a data set or data space “Y.” The ambient “space” for each modality may represent the possible range of values that the data may take in that modality (e.g., as may be captured by respective sensors in that modality).

Labeled multi-modal training data includes pairs of corresponding data samples in each modality. That is, the positive training data includes data in each modality that should correspond to one another across the trained multi-modal model. A first example training pair 205A includes an image of a cat in the first ambient space 200A and a corresponding text string (“A picture of a cat.”) in the second ambient space 200B. Similarly, the second example training pair 205B includes a photo of a dog and a corresponding text string describing the image (“A photo of a dog.”). For convenience of discussion, the data sample of the first training pair 205A in the first ambient space 200A is denoted x₁ and the data sample of the first training pair 205A in the second ambient space 200B is denoted y₁. Similarly, the data sample of the second training pair 205B is denoted x₂ in the first ambient space 200A and denoted y₂ in the second ambient space 200B.

To learn a shared latent space 240, the data samples of the respective modalities are applied to the corresponding unimodal encoders 210A-B to determine latent representations in modality-specific latent spaces 220A-B. The latent representations in the modality-specific latent spaces 220A-B are then applied to respective adaptor models that determine a representation of the data samples in the shared latent space 240. As discussed above, the unimodal encoders 210A-B may be trained on data for each respective modality, such that the modality-specific latent spaces 220A-B encode semantically useful information based on the training of the unimodal encoders. In some embodiments, the unimodal encoders 210A-B may be pre-trained or trained by other systems and may be, for example, best-in-class encoders for each particular modality. As particular examples, image encoders may include DINOv2 or UNICOM, text encoding may include BGE and E5, and audio encoding may include HTS-AT and Whisper encoders, each of which has demonstrated effective performance on the respective individual modalities. As the training data for individual modalities is typically relatively large, particularly compared to multi-modal data, the unimodal encoders 210A-B may thus be relatively complex and trained with a large amount of training data compared to the amount of multi-modal training data and the complexity of the adaptor models 230A-B.

In some embodiments, multiple unimodal encoders may be used on the same data sample and the resulting latent representations from each unimodal encoder may be combined to generate the latent representation for the modality used by the multi-modal model. For example, the latent representations of audio encoders, such as HTS-AT and Whisper, may be concatenated to generate a latent representation that includes the different aspects represented in the latent representations generated from each unimodal encoder. This permits the combination of multiple unimodal encoders and the multi-modal model to benefit from the respective strengths of each encoder. To invert this process and obtain an ambient data sample from the combined latent space, the respective latent representations may be separated from the combined (e.g., concatenated) unimodal latent representation and one or both of the unimodal encoders may be applied to generate a data sample in ambient space. In some embodiments the data sample from one of the unimodal encoders is automatically selected, for example based on an estimated likelihood/probability of the data sample, a measure of unimodal encoder confidence, as a default (e.g., the better-performing model on most data sets) or by another means.

In various embodiments, the unimodal encoders 210A-B remain fixed during training of the adaptor models 230A-B. As such, the resulting latent representations in the modality-specific latent spaces 220A-B may also be constant during training of the adaptor models 230A-B. This enables the adaptor models 230A-B to be trained with significantly less compute and reduced memory requirements as the adaptor models 230A-B may be trained without keeping the data samples in ambient spaces 200A-B or the unimodal encoders 210A-B in memory for application of training gradients. In addition, in some embodiments the latent representations in the modality-specific latent spaces 220A-B may be pre-computed (relative to training the adaptor models 230A-B) and stored in a data store, such as the latent representation data store 160. Thus, for each pair of multi-modal training data, the respective data samples in ambient spaces may be converted to the latent representations in the respective modalities and the data samples in ambient space may be freed from memory. In addition to the positive examples shown in FIG. 2, negative training pairs may also be generated by combining data samples of different modalities that are not labeled as positive pairs (e.g., by pairing the image of a dog with the text “A picture of a cat.”).

Using the modality-specific latent spaces, adaptor models 230A-B are used to determine respective positions of the data samples in the shared latent space 240. The adaptor models 230A-B are generally lower-complexity models relative to the modality-specific unimodal encoders 210A-B. The shared latent space 240 in some embodiments may be a lower dimensionality than the modality-specific latent spaces 220A-B, and may have the same dimensionality as the modality-specific latent space 220A-B having the relatively higher or lower dimensionality. In one embodiment, the adaptor models 230A-B are multi-layer perceptrons (MLPs). The adaptor models 230A-B in one embodiment have an inverted bottleneck architecture and may include one or more residual blocks with a projection layer. As one example, the dimensionality of the shared latent space 240 may be 512 (i.e., generating a latent representation in the shared latent space having a latent vector of length 512).

During training, the training process is generally configured to encourage the positions of the positive training pairs closer to one another and the negative training pairs apart in the shared latent space 240. In this example of positive training pairs, the objective may thus aim to minimize the distance 245A-B between the respective positive training pairs 205A-B. The specific training loss used may differ in various embodiments, and in one embodiment may be a contrastive loss that encourages similar positions in the shared latent space for positive pairs (pulling them closer to one another) and discourages similar positions for negative pairs (pushing them away from one another). The contrastive loss may then be applied to modify parameters of the adaptor models 230A-B based on the fixed modality-specific latent representations of the training pairs.

Although the unimodal encoders may be relatively complex, by using unimodal encoders that are extensively trained to learn meaningful latent spaces with a large volume of modality-specific data, effective multi-modal models can be learned with relatively simple adaptor models. As such, in certain embodiments, the adaptor models may be trained with a single GPU and memory, avoiding significant overhead and compute of distributed training of the adaptor models. In addition, the unimodal encoders may be applied ahead of time to generate the respective latent representations, and in some embodiments sequentially, obviating the need to hold both unimodal encoders in memory at once. As a result, this architecture and training approach enables efficient and effective learning of the shared latent space 240 while maintaining effective use of the learned latent spaces from the unimodal encoders 210A-B.

### Synthetic Data in Latent Space

FIG. 3 shows an example dataflow for generating synthetic training data pairs, according to one embodiment. Relative to unimodal models, reliable training data for multi-modal data is typically difficult to obtain and may often require more than simply applying a label (e.g., in contrast to unimodal encoders trained as classifiers with class labels). For example, for image-text or image-audio, alignment between the semantic meaning of particular words and the particular image may be essential for effectively learning a correspondence between the image and the text/audio. For a particular image, an audio or textual description of “a man walking” versus “a man walking with a cane and a yellow hat” may yield significantly different model qualities, such that the particular associations between modalities in the training data may significantly affect the resulting multimodal model. For these reasons, high-quality training data is typically difficult to obtain.

To better leverage an existing training data set, the training data may be augmented with synthetic data points generated based on the unimodal latent spaces. To do so, rather than modify training data in the ambient space, which can be difficult to generalize and may often require detailed fine-tuning to avoid undesirable results, the synthetic data points are generated in the unimodal latent spaces 300A-B. While the ambient spaces may often include many “regions” that have no semantic meaning (e.g., audio that consists of meaningless frequencies), the latent representations signify meaningful distinguishing information about the data samples obtained from applying the trained unimodal models.

To do so, a synthetic data point is generated that blends the latent representations of two training data pairs. The training data pairs typically have the same label (e.g., both training data pairs are positive examples or both training data pairs are negative examples). As noted above for FIG. 2, each training data pair is denoted subscript “1” and “2” in FIG. 3. Each training data pair thus has a respective latent representation Zₓ₁ and Zₓ₂ in the first unimodal latent space 300A. Similarly, the training data pairs have a respective latent representation Z_{y1} and Z_{y2} in the second unimodal latent space 300B. Conceptually, the respective latent representations in each modality have respective paths 308A-308B between them in the latent spaces 300A-300B. Each end of the “path” in a unimodal latent space is a latent representation for a training pair that has a corresponding latent representation in the other unimodal latent space. That is, the points Zₓ₁ and Z_{y1} at one “end” of each path 308A-B are a training data pair, and the points Zₓ₂ and Z_{y2} at the other “end” of each path 308A-B are another training data pair having the same label. The intuition of generating the synthetic data point is that as the ends of the path 308A-B both have the same label, the path 308A-B “should” have the same label and points along the path should correspond to one another when the adaptive models 330A-B and the shared latent space 340 is well-trained.

To generate this data point, a blending ratio between the training data pairs is determined that indicates the proportion of each training data pair to be represented in the synthetic data point. This may also be understood as the length of the path 308A-B at which to generate the synthetic data point. As an example, a blending ratio of 75% of a first training pair (x₁ and y₁) and 25% of a second training pair is shown in FIG. 3 as respective positions 305A-B along the path 308A-B. In some embodiments, the blending ratio is determined by sampling from a probability distribution, such as a beta distribution. The synthetic data pair may then be generated as a latent representation 310A-B in each respective unimodal latent space 320A-B by combining the latent representations of the training pairs according to the blending ratio. The blending may include, for example, interpolating the latent vectors of each training data pair.

Formally, two multimodal training pairs have latent representations (zₓ, z_{y}) and (\hat{z}ₓ, \hat{z}_{y}) generated from applying unimodal models g_{X} and g_{Y} to respective ambient space data samples (x, y) and (\hat{x}, ŷ) as (zₓ, z_{y})≙(g_{X}(x), g_{Y}(y)) and (\tilde{z}ₓ, \tilde{z}_{y})≙(g_{X}(\hat{x}), g_{X}(ŷ)). In one embodiment, to generate the synthetic data pair (\tilde{z}ₓ, \tilde{z}_{y}) with a blending ratio λ, the synthetic data pair is defined as:

$$( {\tilde{z}}_{x} , {\tilde{z}}_{y} ) {=}^{Δ} λ ( {z}_{x} , {z}_{y} ) + ( 1 - λ ) ( {\hat{z}}_{x} , {\hat{z}}_{y} ) \qquad Equation 1$$

As such, the blending ratio λ may define the portion (e.g., a weighted combination) of the latent representation in each unimodal latent space for each training pair to generate the synthetic data pair.

The synthetic data pair 310A-B may then be applied to the adaptor models 330A-B to generate respective positions 350A-B in the shared latent space 340 that may be used to train the adaptor models as with other training data. By generating training data between data pairs having the same label, the regions between the known training pairs may be expected to also have that label when the latent representations effectively capture semantic information about the data. As such, training the model may also learn with an objective to minimize the distance 360 between the synthetic data pair in the shared latent space 340. In addition to the non-synthetic training pairs, the inclusion of the synthetic data pair may also encourage the shared latent space 340 to learn a “path” or “contour” between the non-synthetic training data pairs equivalent to the path 308A-B in the unimodal latent spaces. This additional structure may provide further means for learning additional meaning and structure in the shared latent space 340 with the adaptor models 330A-B. In addition to positive training pairs, synthetic data points may likewise be generated with negative training pairs to provide additional negative data points based on the semantic information encoded in the unimodal latent spaces.

### Multi-Modal Model Application

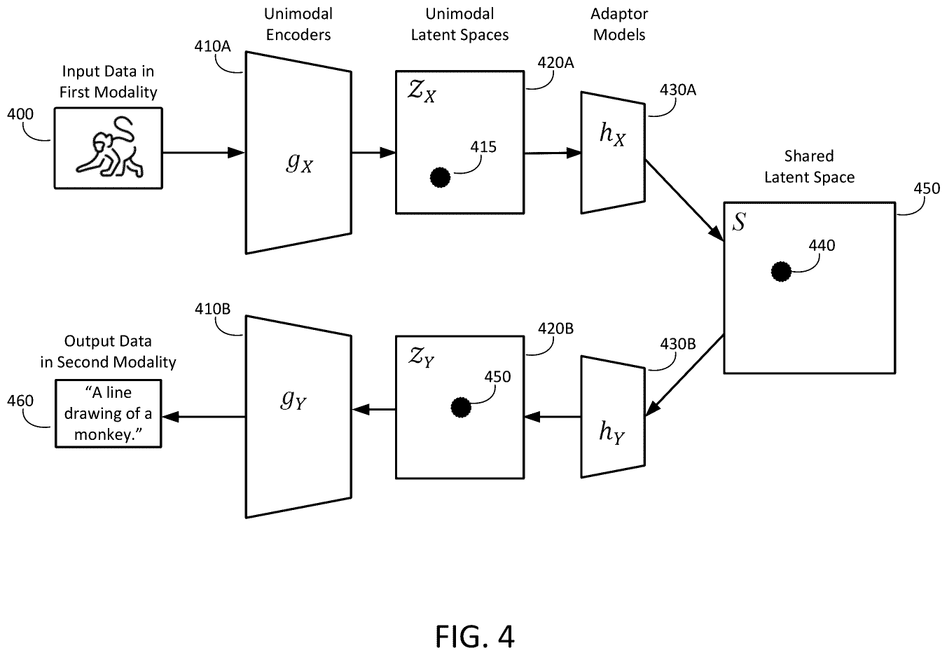

FIG. 4 shows an example data flow for applying a multi-modal model to a data sample in a first modality and obtain a data sample in a second modality, according to one embodiment. This data flow may be performed, for example, by an inference module 140. This is one use for a multi-modal model trained with the approaches discussed herein; additional examples may use the trained multi-modal model to determine a likely correspondence between data points in different modalities (e.g., by measuring cosine similarity in the shared latent space) among other applications. In this example, the first modality is an image and the second modality is a corresponding textual description. In the example of FIG. 4, an input image 400 is input to a first unimodal encoder 410A to generate a latent representation 415 in a unimodal latent space 420A of the first modality. A trained fusion adaptor 430A for the first modality is applied to the latent representation 415 to generate the latent representation 440 in the shared latent space 450. To obtain the data sample in the second modality, the latent representation 440 is applied to the inverted adaptor model 430B to generate the latent representation 450 in the second unimodal latent space 420B and then to the unimodal encoder 410B of the second modality. The resulting output textual description 460 in the second modality corresponds to a description of the input image 400.

### Model Training

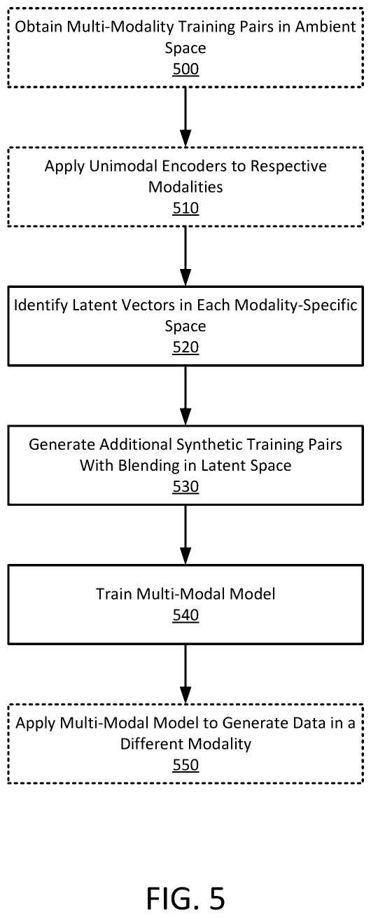

FIG. 5 provides an example method for training a multi-modal model, according to one or more embodiments. This method may include training the multi-modal model as well as generating synthetic data as discussed above and may be performed, for example, by the model training module 110 and data augmentation module 120. Initially, the training process obtains 500 multi-modality training pairs in an ambient space. For example, the modalities for images and descriptive text may include training pairs of images and accompanying descriptive text. The training data pairs may then be processed by applying 510 respective unimodal encoders to generate latent representations (e.g., latent vectors) in each unimodal latent space. As discussed above, in various embodiments, the latent representations may be pre-computed from the perspective of the training process, such that, in some embodiments, the existing latent vectors, previously determined from the multi-modal training data pairs, are identified 520 and may be retrieved for training the multi-modal model. In some embodiments, the method may generate additional synthetic training pairs 530 by blending training pairs in the respective unimodal latent spaces as discussed above. Then, using the pairs of unimodal latent representations, which may include the generated synthetic data, is used to train 540 the multi-modal model, including the adaptor models discussed above. Likewise, as the latent representations are used in the training, the training 540 may be performed without storing the ambient space data samples or unimodal encoders in memory during training, enabling effective results with dramatically reduced training requirements. After training, the trained model may then be used for various inference purposes, such as applying 550 the multi-modal model to generate data in one modality based on an input in another modality.

### Effect of Data Variation and Diversity

As discussed above, multi-modal data sets may be relatively expensive to obtain. As such, it may be useful determine how different aspects of the training data affect performance of a trained multi-modal model. These aspects may then be used to determine what additional training data may best further improve the model performance.

FIG. 6 shows example experimental performance of a multi-modal model according to various aspects of a training data set. In particular, FIG. 6 shows how the model performance may differ when the training data subset is modified, the “quality” of the training data differs, and the comparative performance of “diverse” subsets of training data. As discussed further below, the diverse subset of training data is a subset of the training data that is “diverse” with respect to the latent representations of the training data (e.g., after application of a unimodal encoder). A first chart 600 shows the recall of the multi-modal model as the size of a training data set changes by modifying the portion of training data used to train the model. A second chart 610 evaluates the recall of the trained model according to different quantities of data having different qualities. The “H 500K” column represents a training data set of 500 k human-curated training data pairs. The “W 500K” column represents a training data set of 500 k automated training data pairs automatically obtained from the Internet, while the “W 3 M” column represents a training data set of 3 million training data pairs automatically obtained from the Internet.

The first chart 600 shows that as the quantity of training data increases (e.g., a portion of all available training data pairs) the recall generally shows diminishing returns with additional training data (as a total quantity). Similarly, the quality of training data may significantly affect model recall; the second chart 610 shows that for this model architecture, the “high-quality” human-labeled training pairs exhibits significantly improved performance relative to the same quantity (500K) of “low-quality” training pairs. For the “low-quality” training pairs to exhibit similar performance to the high-quality training pairs, it requires six times the training data (and accompanying training computation): 3 million training pairs of low-quality data to obtain similar performance to 500K training pairs of high-quality data.

The third chart 620 shows relative performance of a “diverse” subset of training data having a particular size compared to a randomly-selected subset of the training data having the same size. For example, performance of a model trained with 1,000 training data samples selected as a “diverse” subset of a larger training data set is compared with performance of a model trained with 1,000 training data samples that were randomly selected. The third chart 620 thus shows the relative performance of the model as the quantity (i.e., a percentage) of the selected subset increases. As such, the relative performance when the selected subset is 100% is identical, as the selected subsets in both instances include all training data pairs. However, the third chart 620 illustrates that in some circumstances the diversity of the training data may provide significantly improved performance relative to randomly-selected training data. Since additional training data may incur additional computational and other costs, the increased performance of diverse data subsets may mean that in some circumstances effective models may be trained by selecting a diverse subset of training data. This may allow the model to learn from meaningfully different training data and reduce the amount of training data that provides duplicative or “significantly similar” information to be learned by the model.

As one approach for selecting the diverse subset of training data, the training data may be characterized according to the latent representations of the training data in a particular modality. For example, the unimodal encoder may be applied to the corresponding data samples of the training data. The diverse subset of training data may be obtained by generating a similarity matrix that includes elements of each training data item. The similarity matrix may be a symmetric matrix in which a value at the intersection of two items describes the similarity of those items. In this example, the similarity describes the similarity of the items in the latent space. To determine a diverse subset of items, a determinant point process (DPP) may be applied to the similarity matrix. The determinant point process selects data points from the similarity matrix according to the informational value in the similarity matrix, particularly with respect to the effect of an included item on the determinant of a resulting matrix. In some embodiments, a k-DPP process is used that selects a maximum number of items, k, with a determinant point process. The “mode” of the k-DPP is used to select a “maximally diverse” subset of items based on the similarity matrix. By specifying a maximum number of items k based on a portion of the total number of training items (e.g., 10% of the total training items), the “maximally diverse” subset of the training data may be selected and used to train the model. As shown in FIG. 6, the performance of a model trained with the maximally diverse subset may be compared with a model trained with a randomly selected subset of the same size, and this may be repeated at several subset sizes, enabling evaluation of the relative benefit of different “concentrations” of diversity (as increasingly large subsets of the same overall set include sequentially less-diverse training points).

To compute the similarity matrix and describe the similarity between training items, the latent representation (e.g., latent vector) of each training item may be compared, for example, with a cosine similarity. However, the resulting similarity score between items, when determined exclusively by the cosine similarity, may reduce the effective variation between items, such that the overall similarity matrix has a relatively low rank and prevents additional items from being selected beyond the dimensionality of the latent representation. In one embodiment, to generate additional variation and enable selection of diverse points in quantities above the dimensionality of the latent space, an exponent may be applied to the cosine similarity and, in some cases, a constant added to further vary the similarity score. In one embodiment, the similarity score for a first latent representation z and second latent representation z′ is determined by:

$$( z , {z}^{′} ) = {( z \cdot {z}^{′} + 1 )}^{2} \qquad Equation 2$$

where z·z′ is the cosine similarity between the latent representations. By using this similarity score that modifies a “pure” cosine similarity while retaining effective meaning, the deterministic point process can be applied to the latent space representations effectively and to select a subset of items larger than the dimensionality of the latent space.

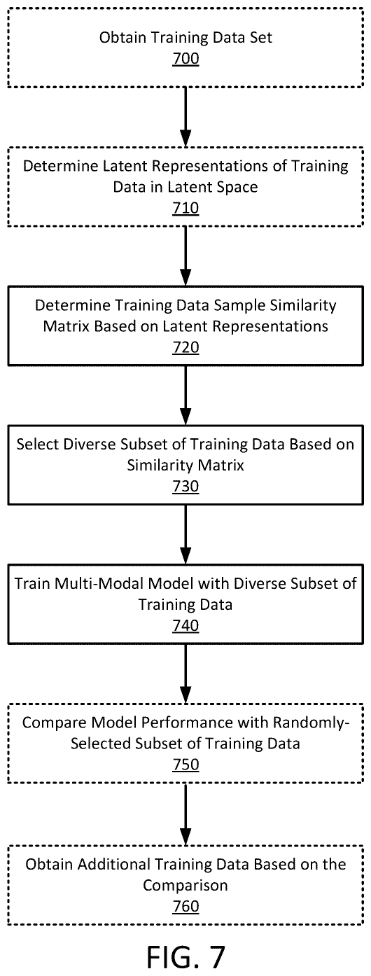

FIG. 7 is an example flowchart for determining and using a diverse subset of training data based on latent representations. This process may be performed, for example, by a training evaluation module 130 as discussed above. Initially, a training data set may be obtained 700, which may include all training data samples to be evaluated with respect to selection of a diverse subset. Next, if not already available, the associated data samples in ambient space for the training data may be applied to an encoder, such as a unimodal encoder as discussed above, to determine 710 latent representations of the training data in a latent space. Next, the training data sample similarity matrix is determined 720 based on the latent representations, for example, by applying an exponent to a cosine similarity of the latent representations for each item pair as discussed with Equation 2 discussed above. Using the similarity matrix, a diverse subset of training data is selected 730, such as with a deterministic point process.

The diverse subset of training data is then used to train 740 a model, such as a multi-modal model as discussed above. Because the ‘maximally diverse’ subset may represent the portions of the training data from which the model is expected to learn the most (i.e., they represent the “most-different” portions of the latent space), in some embodiments, the multi-modal model trained with the selected training subset based on the diversity in latent representations may then be used for subsequent inference. In additional examples, the performance of the trained model may be compared 750 with additional trained models, such as a subset of training data that was randomly selected. This process may be repeated with different sized subsets to determine the respective effect of diversity on the trained model for different portions of overall training data. Using the performance of the model trained with the diverse subset, optionally in conjunction with other ways to measure the effect of modifying the training set (e.g., quantity and quality discussed in FIG. 6), the relative value of obtaining additional training data can be estimated (e.g., extrapolated) from the performance and used to determine what additional training data may be expected to most improve the model performance. The expected relative performance benefit may then be used to obtain additional training data using the comparisons. Because training data for certain types of models, such as multi-modal data, may be difficult to obtain in high quality, these objective performance metrics for evaluating the relative value of further training data may optimize the benefit of incremental training data of different types. When the additional data is obtained 760, the model may be retrained and the expected performance confirmed.

As discussed above, these various approaches to model architecture, training, training data augmentation, and data evaluation may significantly improve efficient use of multi-modal models, enabling reduced computational requirements, improved results with limited training data, and determining which aspects of further training data may best improve the model performance.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for training a multi-modal model, comprising:
a processor configured to execute instructions; and
a non-transitory computer-readable memory having a set of instructions executable by the processor for:
identifying a training data set of data samples for a multi-modal model;
identifying latent representations of the data samples in a latent space;
determining a similarity matrix between the data samples describing the similarity of the data samples in the latent space;
selecting a diverse subset of data samples of the training data set based on the similarity matrix; and
training a multi-modal model based on the diverse subset of data samples.

2. The system of claim 1, wherein the latent representations of the data samples in the latent space are generated by a trained unimodal encoder applied to the data samples in an ambient space.

3. The system of claim 1, wherein a value of a position in the similarity matrix indexed by a first data sample and a second data sample is based on a cosine similarity between latent representations of the first data sample and the second data sample.

4. The system of claim 3, wherein the value of a position in the similarity matrix is further based on an exponent applied to the cosign similarity.

5. The system of claim 1, wherein selecting the diverse subset of data samples comprises applying a determinantal point process (DPP) to the similarity matrix.

6. The system of claim 1, wherein selecting the diverse subset of data samples is based on a determinant and a selected number of items is higher than a dimensionality of the latent space.

7. The system of claim 1, wherein the set of instructions is further executable for:
determining a performance metric of the multi-modal model trained on the diverse subset of data samples;
comparing the performance metric to another performance metric of the multi-modal model trained on a randomly-selected subset of data samples; and
based on the comparison, determining additional training data for training the multi-modal model.

8. A method for training as multi-modal model, comprising:
identifying a training data set of data samples for a multi-modal model;
identifying latent representations of the data samples in a latent space;
determining a similarity matrix between the data samples describing the similarity of the data samples in the latent space;
selecting a diverse subset of data samples of the training data set based on the similarity matrix; and
training a multi-modal model based on the diverse subset of data samples.

9. The method of claim 8, wherein the latent representations of the data samples in the latent space are generated by a trained unimodal encoder applied to the data samples in an ambient space.

10. The method of claim 8, wherein a value of a position in the similarity matrix indexed by a first data sample and a second data sample is based on a cosine similarity between latent representations of the first data sample and the second data sample.

11. The method of claim 10, wherein the value of a position in the similarity matrix is further based on an exponent applied to the cosign similarity.

12. The method of claim 8, wherein selecting the diverse subset of data samples comprises applying a determinantal point process (DPP) to the similarity matrix.

13. The method of claim 8, wherein selecting the diverse subset of data samples is based on a determinant and a selected number of items is higher than a dimensionality of the latent space.

14. The method of claim 8, wherein the set of instructions is further executable for:
determining a performance metric of the multi-modal model trained on the diverse subset of data samples;
comparing the performance metric to another performance metric of the multi-modal model trained on a randomly-selected subset of data samples; and
based on the comparison, determining additional training data for training the multi-modal model.

15. A non-transitory computer-readable medium, the non-transitory computer-readable medium comprising instructions executable by a processor for:
identifying a training data set of data samples for a multi-modal model;
identifying latent representations of the data samples in a latent space;
determining a similarity matrix between the data samples describing the similarity of the data samples in the latent space;
selecting a diverse subset of data samples of the training data set based on the similarity matrix; and
training a multi-modal model based on the diverse subset of data samples.

16. The computer-readable medium of claim 15, wherein the latent representations of the data samples in the latent space are generated by a trained unimodal encoder applied to the data samples in an ambient space.

17. The computer-readable medium of claim 15, wherein a value of a position in the similarity matrix indexed by a first data sample and a second data sample is based on a cosine similarity between latent representations of the first data sample and the second data sample.

18. The computer-readable medium of claim 17, wherein the value of a position in the similarity matrix is further based on an exponent applied to the cosign similarity.

19. The computer-readable medium of claim 15, wherein selecting the diverse subset of data samples comprises applying a determinantal point process (DPP) to the similarity matrix.

20. The computer-readable medium of claim 15, wherein selecting the diverse subset of data samples is based on a determinant and a selected number of items is higher than a dimensionality of the latent space.
